(19) United States
(12) Patent Application Publication
(10) Pub. No.: US 2025/0041960 A1
(43) Pub. Date: Feb. 6, 2025

(54) Apparatus for Welding Electrode Tabs and Method for Welding Electrode Tabs

(71) Applicant: LG Energy Solution, Ltd., Seoul (KR)

(72) Inventors: Ah Ram Park, Daejeon (KR); Yong Tae Lee, Daejeon (KR); Seung Byung Lee, Daejeon (KR); Seok Je Kim, Daejeon (KR)

(73) Assignee: LG Energy Solution, Ltd., Seoul (KR)

(21) Appl. No.: 18/713,969

(22) PCT Filed: Nov. 29, 2022
(86) PCT No.: PCT/KR2022/019107

§ 371 Date: May 28, 2024

(30) Foreign Application Priority Data
Nov. 29, 2021 (KR) 10-2021-0167739

(51) Int. Cl. B23K 11/06; B23K 11/00; B23K 101/36; H01M 50/536

(52) U.S. Cl. CPC B23K 11/06; B23K 11/002; H01M 50/536; B23K 2101/36

(57) ABSTRACT

An apparatus and method for welding electrode tabs protruding from an electrode assembly to each other, which may include a guide part configured to gather the electrode tabs; and a welding part configured to weld the electrode tabs gathered by the guide part on a predetermined welding area. The guide part may be configured to press the electrode tabs toward the electrode assembly, while moving toward the electrode assembly, such that a length from the electrode assembly to the welding area increases in at least a portion of the electrode tabs before being welded by the welding part. Accordingly, some aspects of the present invention may prevent the electrode tabs from disconnecting.

### CROSS-REFERENCE TO RELATED APPLICATIONS

The present application is a national phase entry under U.S.C. § 371 of International Application No. PCT/KR2022/019107 filed Nov. 29, 2022, which claims priority to Korean Patent Application 10-2021-0167739, filed on Nov. 29, 2021, which is hereby incorporated by reference in its entirety.

### TECHNICAL FIELD

The present disclosure relates to an apparatus for welding electrode tabs and a method for welding the electrode tabs.

### BACKGROUND ART

Unlike primary batteries, which are not chargeable, secondary batteries are chargeable and dischargeable, and are widely used in electronic devices such as mobile phones, notebook computers, and camcorders. Secondary batteries are also commonly used in larger devices, such as electric vehicles. Particularly, since lithium secondary batteries have larger capacities than nickel-cadmium or nickel-hydrogen batteries, and have higher energy densities, their use has rapidly increased.

Secondary batteries may be classified into cylindrical or prismatic batteries in which an electrode assembly is built in a cylindrical or prismatic metal can, respectively, and pouch-type batteries, in which an electrode assembly is built in a pouch-type case provided as an aluminum lamination sheet.

FIG. 1 illustrates an example of a pouch-type secondary battery. A pouch-type secondary battery 1 includes an electrode assembly 10, in which electrodes and separators are alternately stacked, and a pouch 20, into which the electrode assembly is accommodated. Electrode tabs 15 may be connected to the electrodes of the electrode assembly 10. The electrode tabs 15 may be welded to each other on a predetermined area and then connected to an electrode lead 17. The pouch 20 includes a cup part 21 having a recessed shape to accommodate the electrode assembly 10. Pouch 20 may be configured to include one or two cup parts 21. FIG. 1 illustrates an example in which the pouch 20 includes a left cup part and a right cup part. A peripheral portion 23 (terrace) is formed around a circumference of the cup part 21 by sealing.

However, when pulling force is applied to the electrode tabs 15 due to deformation of the peripheral portion 23 of the pouch 20, the electrode tabs 15 may gradually tighten and then disconnect. Alternatively, even when the pulling force is applied to the electrode tabs 15 due to expansion of the pouch 20, the electrode tabs 15 may gradually tighten and then disconnect. Such disconnections may cause afire. Pursuant to recent demands for high capacity and high performance, a length of the peripheral portion 23 in pouch-type secondary batteries is reduced to increase their energy density. Accordingly, a ‘length of the electrode tab 15 from the electrode assembly 10 to a welding point of each of the electrode tabs 15’ may be reduced, resulting in an increased risk of disconnection.

### Technical Problem

An object of the present invention is to provide an apparatus and method for welding an electrode tab, in which a ‘length of an electrode tab from an electrode assembly to a welding point of each of electrode tabs’ increases to prevent the electrode tabs from disconnecting, even in pouch-type secondary batteries having high capacity and high performance.

### Technical Solution

In one embodiment of the present invention, an apparatus for welding electrode tabs protruding from an electrode assembly to each other may include: a guide part configured to gather the electrode tabs and a welding part configured to weld the electrode tabs gathered by the guide part on a predetermined welding area. The guide part may be configured to press the electrode tabs toward the electrode assembly, while moving toward the electrode assembly, so that a length from the electrode assembly to the welding area increases in at least a portion of the electrode tabs before being welded by the welding part.

In another embodiment, the guide part may include a first rod disposed at one of upper and lower sides of the electrode tabs and a second rod disposed at the other of the upper and lower sides of the electrode tabs when electrodes and separators of the electrode assembly are stacked in a vertical direction perpendicular to the ground. The first rod may be configured to move in a proximity direction that is a direction directed toward the electrode assembly.

In further another embodiment, the first and second rods may be configured to relatively move toward each other so as to adjust a distance therebetween in the vertical direction.

In further another embodiment, the first rod may be configured to move in the proximity direction in a state in which the first and second rods relatively move toward each other to press the electrode tabs in the vertical direction.

In further another embodiment, the first rod may include: a first rod body configured to move in the proximity direction and a first rod roller disposed on an end toward the electrode tabs of upper and lower ends of the first rod body, so as to be in contact with the electrode tab that is disposed to be closest among the electrode tabs to rotate when moving in the proximity direction.

In further another embodiment, the second rod may include: a second rod body configured to move in the proximity direction by being interlocked with the first rod body and a second rod roller disposed on an end toward the electrode tabs of upper and lower ends of the second rod body, so as to be in contact with the electrode tab that is disposed to be closest among the electrode tabs to rotate in a state of pressing the electrode tabs in the vertical direction together with the first rod roller when moving in the proximity direction.

In further another embodiment, the guide part may include a first rod part disposed at one of upper and lower sides of the electrode tabs and a second rod part disposed at the other of the upper and lower sides of the electrode tabs when electrodes and separators of the electrode assembly are stacked in a vertical direction perpendicular to the ground, wherein the first rod part may include a first pressing rod for pressing the electrode tabs in the vertical direction and a first movable roller configured to move toward the electrode assembly and configured to pull at least a portion of the electrode tabs toward the electrode assembly, and the second rod part may include a second pressing rod that relatively moves in the vertical direction with respect to the first pressing rod to press the electrode tabs in the vertical direction together with the first pressing rod.

In further another embodiment, the second rod part may further include a second movable roller configured to move toward the electrode assembly by being interlocked with the first movable roller in a state in which the electrode tabs are pressed in the vertical direction by the first and second pressing rods.

In further another embodiment, a method for welding electrode tabs protruding from an electrode assembly may include: (a) pressing the electrode tabs upward and downward to gather the electrode tabs when electrodes and separators of the electrode assembly are stacked in a vertical direction perpendicular to the ground; (b) pressing the electrode tabs toward the electrode assembly in a state of gathering the electrode tabs to pull at least a portion of the electrode tabs toward the electrode assembly; and (c) welding the electrode tabs on a predetermined welding area after the pulling.

In further another embodiment, the at least a portion of the electrode tabs may be welded in a state in which a length from the electrode assembly to the welding area increases by the pulling.

In further another embodiment, step (b) may include allowing a first rod disposed at one of upper and lower sides of the electrode tabs to move toward the electrode assembly so as to press the at least a portion of the electrode tabs toward the electrode assembly.

In further another embodiment, step (a) may include allowing a second rod disposed at the other of the upper and lower sides of the electrode tabs to press the electrode tabs upward and downward together with the first rod.

In further another embodiment, the first rod may include a first rod roller configured to be movable in a proximity direction that is directed toward the electrode assembly, in a separation direction that is a direction away from the electrode assembly, and in an upward or downward direction and configured to be in contact with the electrode tab that is disposed to be closest among the electrode tabs to rotate when moving in the proximity direction.

### Advantageous Effects

According to some embodiments of the present invention, since at least a portion of the electrode tabs is pulled toward the electrode assembly to weld the electrode tabs to each other, the length from the electrode assembly to the welding area in at least a portion of the electrode tabs increases. Therefore, in the case of the battery manufactured according to the present invention, even though the pulling force is applied to the electrode tabs due to the deformation of the peripheral portion (terrace) of the pouch, or even though the pulling force is applied to the electrode tabs due to the expansion of the battery, the electrode tabs may not disconnect.

### DESCRIPTION OF DRAWINGS

FIG. 1 is a perspective view illustrating an example of a pouch-type secondary battery.

FIGS. 2A to 2D are side elevation views for explaining one of the exemplary processes capable of being applied to welding of electrode tabs of a pouch-type secondary battery.

FIG. 3 is a cross-sectional view illustrating a portion of the battery module provided so that the several pouch-type batteries are accommodated in the case.

FIG. 4 is a side elevation view illustrating an apparatus for welding an electrode tab according to Embodiment 1 of the present invention.

FIGS. 5A to 5E are side elevation views for explaining a method for welding electrode tabs through the welding apparatus of FIG. 4.

FIG. 6 is a side elevation view illustrating an apparatus for welding an electrode tab according to Embodiment 2 of the present invention.

### DETAILED DESCRIPTION

Hereinafter, preferred embodiments of the present invention will be described in detail with reference to the accompanying drawings so that those of ordinary skill in the art can easily carry out the present invention. However, the present invention may be implemented in several different forms and is not limited or restricted by the following examples.

In order to clearly explain some embodiments of the present invention, detailed descriptions of portions that are irrelevant to the description or related known technologies that may unnecessarily obscure the gist of some embodiments of the present invention have been omitted, and in the present specification, reference symbols are added to components in each drawing. In this case, the same or similar reference numerals are assigned to the same or similar elements throughout the specification.

Also, terms or words used in this specification and claims should not be restrictively interpreted as ordinary meanings or dictionary-based meanings, but should be interpreted as meanings and concepts conforming to the scope of the present invention on the basis of the principle that an inventor can properly define the concept of a term to describe and explain his or her invention in the best ways.

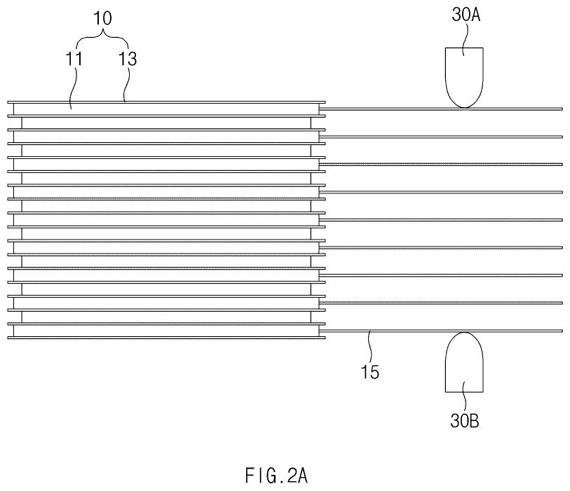

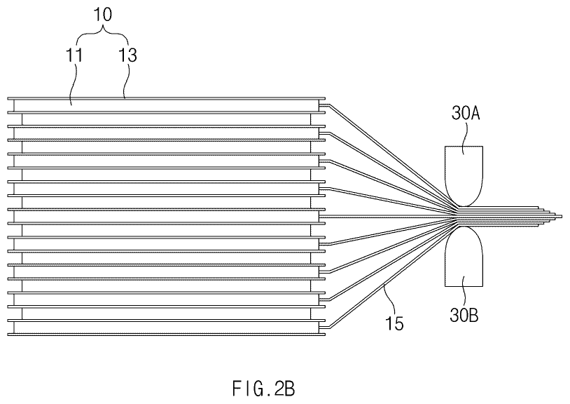

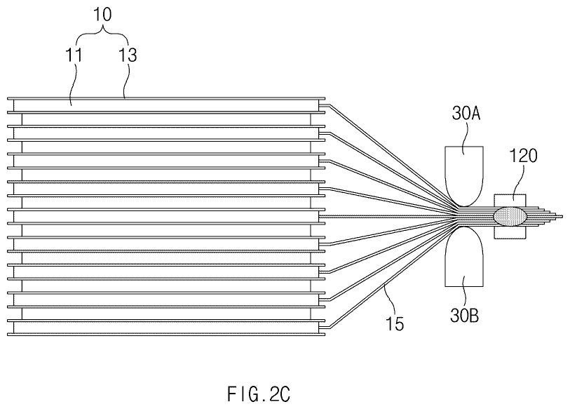

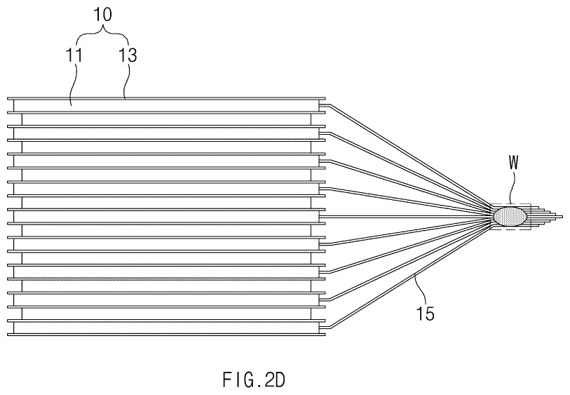

First, a process of welding electrode tabs of a pouch-type secondary battery will be described with reference to FIGS. 2A to 2D. FIGS. 2A to 2D are views for explaining one of the exemplary processes capable of being applied to welding of electrode tabs of a pouch-type secondary battery.

First, the electrode assembly 10 is prepared as illustrated in FIG. 2A. The electrode assembly 10 may be provided by stacking electrodes 11 and separators 13. The electrode 11 includes a positive electrode and a negative electrode. An electrode tab 15 may be connected to the electrode 11. For reference, only the negative electrode tab 15 connected to the negative electrode is illustrated in FIG. 2A for convenience of description. The positive electrode tab connected to the positive electrode may also be provided in the electrode assembly 10 to extend in a direction different from an extension direction of the negative electrode tab 15, and may be welded in the same manner as the negative electrode tab. Next, the electrode tabs 15 are gathered as illustrated in FIG. 2B. For example, the electrode tabs 15 may be gathered by pressing the electrode tabs 15 using two rods 30A and 30B. Next, the electrode tabs 15 are welded through a welding part 120 as illustrated in FIG. 2C.

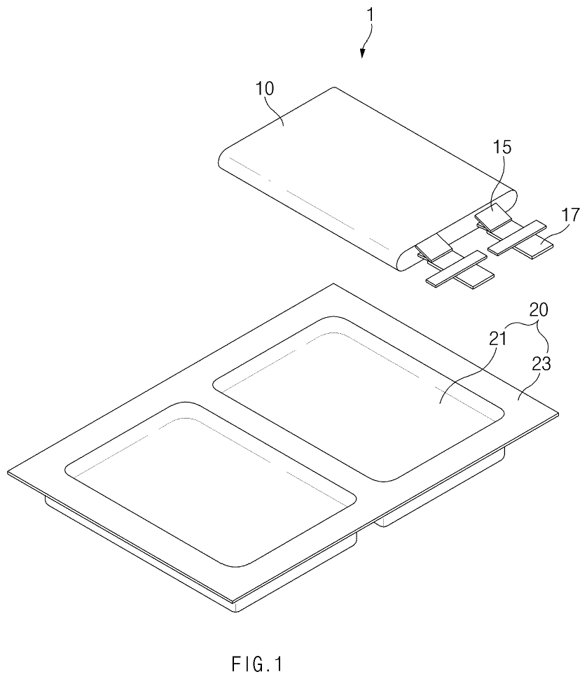

As illustrated in FIG. 2D, an electrode assembly 10, in which the electrode tabs 15 welded to each other on a predetermined welding area W are provided, may be manufactured through these processes. After connecting an electrode lead 17 (see FIG. 1) to the electrode tabs 15, the electrode assembly 10 may be accommodated in the pouch 20 (see FIG. 1) to manufacture the pouch-type battery 1.

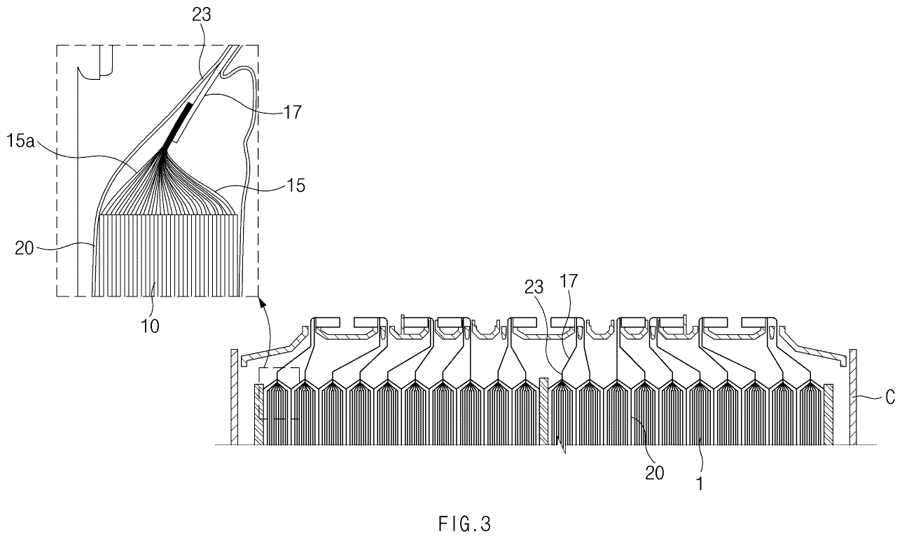

As illustrated in FIG. 3, several pouch-type batteries 1 may be accommodated in one case C and manufactured as a battery module. FIG. 3 is a cross-sectional view illustrating a portion of the battery module provided so that the several pouch-type batteries are accommodated in the case.

However, a peripheral portion 23 of the pouch 20 may be bent during the manufacturing of the battery module. Deformation of the peripheral portion 23 may cause bending of the electrode lead 17 to apply pulling force to the electrode tabs 15 connected to the electrode lead 17 (for example, see electrode tabs 15a in FIG. 3). The force may tightly pull the electrode tabs 15 causing disconnection of the electrode tabs 15. The force may be larger in the outer electrode tab 15a. Even when the battery is expanded, the above disconnection problem may occur.

The present disclosure, which will be described in detail below, is intended to solve the above disconnection problem.

### Embodiment 1

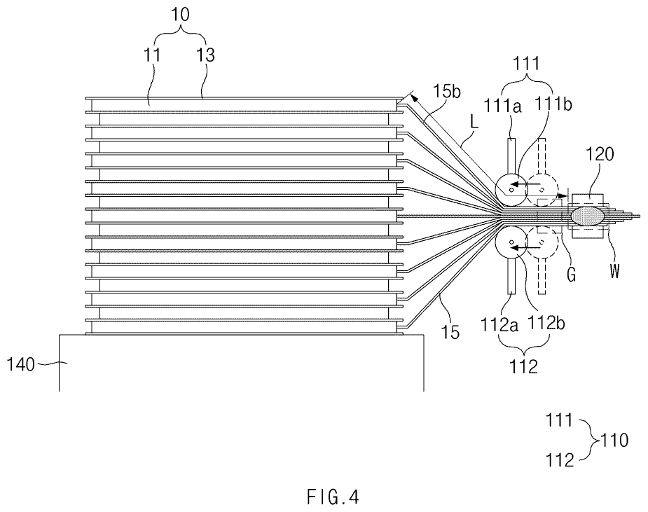

FIG. 4 is a view illustrating an apparatus for welding an electrode tab according to Embodiment 1 of the present invention. An apparatus for welding an electrode tab according to Embodiment 1 of the present invention relates to an apparatus for welding electrode tabs 15 protruding from an electrode assembly 10 to each other and includes a guide part 110 and a welding part 120 as illustrated in FIG. 4. For reference, hereinafter, it is assumed that electrodes 11 and separators 13 of the electrode assembly 10 are stacked in a vertical direction perpendicular to the ground. However, this is merely an example, and the stacking direction of the electrodes 11 and the separators 13 may vary depending on a direction in which the electrode assembly 10 is viewed.

The guide part 110 may be configured to gather the electrode tabs 15. For example, the guide part 110 may include a first rod 111 disposed at one of upper and lower sides of the electrode tabs 15 and a second rod 112 disposed at the other side of the upper and lower sides of the electrode tabs 15. In FIG. 4, the first rod 111 disposed at the upper side and the second rod 112 disposed at the lower side are illustrated. The first and second rods 111 and 112 may gather the electrode tabs 15 on a predetermined area G.

The first and second rods 111 and 112 may move relative to each other in a vertical direction. For example, only the first rod 111 may move toward the second rod 112 when the second rod 112 is in a stationary state, only the second rod 112 may move toward the first rod 111 when the first rod 111 is in a stationary state, or the first and second rods 111 and 112 may move toward each other.

A distance between the first and second rods 111 and 112 may be adjusted by the relative movement of the first and second rods 111 and 112. When the distance between the first and second rods 111 and 112 is reduced, the electrode tabs 15 may be vertically pressed by the first and second rods 111 and 112. Due to this pressure, the electrode tabs 15 may be gathered on a predetermined area G. In this process, the electrode tabs 15 may be bent toward the predetermined gathering area G.

The welding part 120 may be configured to weld the electrode tabs 15 gathered by the guide part 110 on a predetermined welding area W. For example, the welding part 120 may include a horn and an anvil for performing ultrasonic welding. The electrode lead 17 (see FIG. 1) provided to supply electricity to the outside of the battery may be welded to the electrode tabs 15 welded by the welding part 120.

The guide part 110 according to this embodiment may press the electrode tabs 15 toward the electrode assembly 10, while moving toward the electrode assembly 10, before being welded by the welding part 120. Via this pressing, the guide part 110 may increase a reference length L of all or portion of the electrode tabs 15. Here, the reference length L may be a ‘length from the electrode assembly 10 to the welding area W’ of the electrode tab 15.

For example, in the state in which the electrode tabs 15 are vertically pressed by the first and second rods 111 and 112, when the first and second rods 111 and 112 move toward the electrode assembly 10, at least a portion of the electrode tabs 15 may be pulled toward the electrode assembly 10 due to the pressing of the first and second rods 111 and 112. Accordingly, the ‘length L from the electrode assembly 10 to the welding area W’ in the electrode tabs 15 may increase. A remaining portion of the electrode tabs 15 (e.g., a right portion of the welding area W in FIG. 4) may also be pulled toward the electrode assembly 10. For reference, only the first rod 111 may move toward the electrode assembly 10 while the second rod 112 supports the electrode tabs 15. The guide part 110 may press the electrode tabs 15 to a degree that allows the electrode tabs 15 to be pulled.

If the electrode tabs 15 are welded in the pulling state or a state after the pulling, at least a portion of the electrode tabs 15 (e.g., the electrode tab 15b in FIG. 4) may increase in ‘length L from the electrode assembly 10 to the welding area W in the electrode assembly 10’. As described above, the increase in length may prevent the electrode tabs 15 from disconnecting when being pulled tightly because the electrode tabs 15 are tightly pulled only when the electrode tabs 15 are pulled more than before the increase in length. For reference, the force applied to the electrode lead 17 (see FIG. 1) may be transmitted to the electrode tabs 15 through a connection point between each of the electrode tabs 15 and the electrode lead 17.

The pulling of the electrode tabs 15 may increase toward the electrode tab (e.g., the electrode tab 15b) disposed at an outer side (e.g., an upper or lower side with reference to FIG. 4). This is because the electrode tab 15 disposed at the outside is greatly pressed by the guide part 110.

In the apparatus for welding the electrode tabs according to this embodiment, before welded by the welding part 120, the length L from the electrode assembly 10 to the welding area W in at least a portion of the electrode tabs 15 increases. As a result, since the apparatus includes the guide part 110 configured to press the electrode tabs 15 toward the electrode assembly 10, while moving toward the electrode assembly 10, in the case of the battery manufactured by the apparatus for welding the electrode tab according to this embodiment, even if the pulling force is applied to the electrode tabs 15 due to the deformation of the peripheral portion 23 (terrace) of the pouch 20, or even if the pulling force is applied to the electrode tabs 15 due to the expansion of the battery, the electrode tabs 15 may not disconnect.

The guide part 110 according to this embodiment may determine a degree of pulling of the electrode tabs 15 in consideration of the increase in length required to prevent the disconnection from occurring. For example, in the case of the battery module in which a peripheral portion of the pouch 20 is greatly deformed, the guide part 110 may further move toward the electrode assembly 10. As described above, the guide part 110 may control a moving distance toward the electrode assembly 10 to adjust a degree of pulling of the electrode tabs 15, i.e., an incremental degree of the reference length L.

The first rod 111 may include a first rod body 111a configured to move in a direction toward the electrode assembly 10. Hereinafter, the direction toward the electrode assembly 10 (e.g., a left direction with respect to FIG. 4) is referred to as a proximity direction. The first rod body 111a may be a bar or block that rotatably supports the first rod roller 111b to be described later. This may be equally applied to the second rod body 112a to be described later. For reference, the first rod 111 may move not only in the proximity direction but also in a separation direction, i.e., a direction away from the electrode assembly 10 (e.g., in the right direction with reference to FIG. 4). This may be equally applied to the second rod 112.

The first rod 111 may include a first rod roller 111b disposed at a lower end of the first rod body 111a. When the first rod roller 111b moves in the proximity direction, the first rod roller 111b may be in contact with the electrode tab disposed to be closest among the electrode tabs 15 (e.g., the electrode tab disposed at the uppermost side in FIG. 4) to rotate. For example, the first rod roller 111b may move toward the electrode assembly 10 in the state of being in contact with the uppermost electrode tab 15b. Here, the first rod roller 111b may rotate by friction with the electrode tab 15b. When the first rod 111 includes the first rod roller 111b, the electrode tab 15 may be pressed without damage to the electrode tab 15.

Since the first rod 111 according to this embodiment is disposed above the electrode tabs 15, the first rod roller 111b may be disposed on a lower end, which is an end toward the electrode tabs 15 of upper and lower ends of the first rod body 111a. When the first rod is disposed below the electrode tabs, the first rod roller may be disposed on an upper end of the first rod body.

The second rod 112 may also include a second rod body 112a configured to move in the proximity direction. The second rod body 112a may move by being interlocked with the first rod body 111a. For example, in the state in which the electrode tabs 15 are pressed by the first rod roller 111b and the second rod roller 112b to be described later, when the first rod body 111a moves in the proximity direction, the second rod body 112a may move in the proximity direction together with the first rod body 111a.

The second rod 112 may also include the second rod roller 112b disposed on an end toward the electrode tabs 15 of upper and lower ends of the second rod body 112a. In FIG. 4, the second rod roller 112b disposed on the upper end of the second rod body 112a is illustrated. When the second rod roller 112b moves in the proximity direction, in the state in which the electrode tabs 15 are vertically pressed together with the first rod roller 111b, the second rod roller 112b may be in contact with the electrode tab disposed to be closest among the electrode tabs 15 to rotate (e.g., the electrode tab disposed at the lowermost side in FIG. 4).

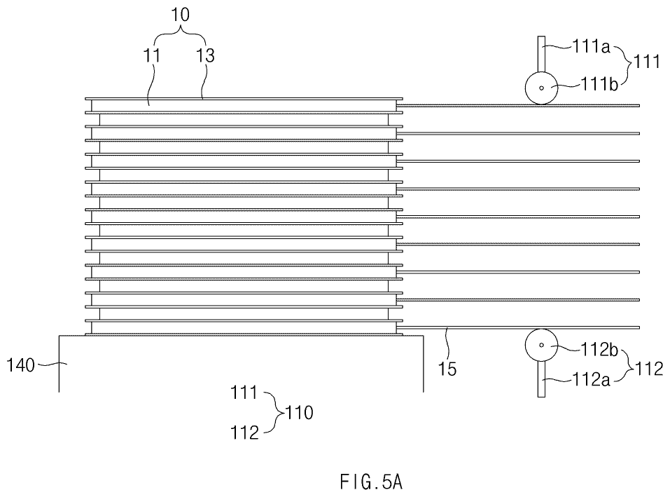

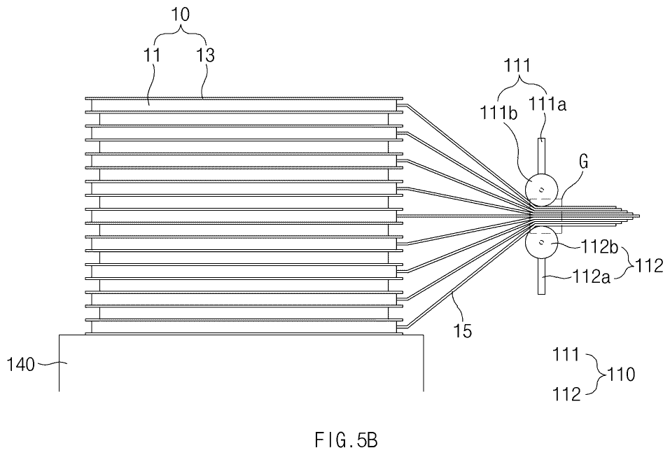

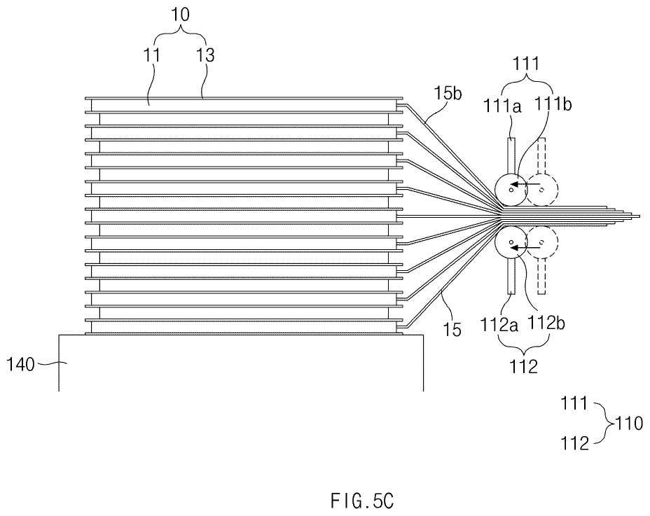

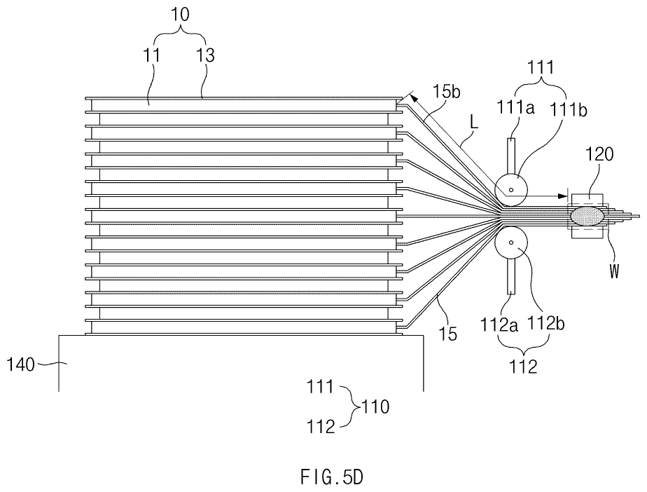

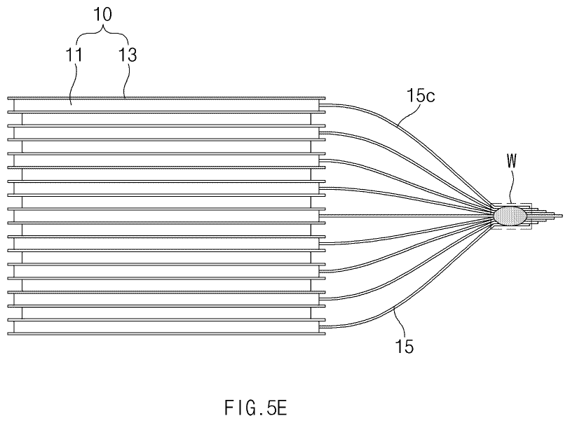

Hereinafter, a process of welding the electrode tabs 15 through the welding apparatus according to this embodiment will be described with reference to FIG. 5. FIG. 5 is a view for explaining a method for welding the electrode tabs through the welding apparatus of FIG. 4.

First, an electrode assembly 10 is prepared as illustrated in FIG. 5A. Here, the electrode assembly 10 may be seated on a seating part 140. The seating part 140 may be a jig or die on which the electrode assembly 10 is seated.

Next, the electrode tabs 15 are gathered as illustrated in FIG. 5B. This may be implemented by an operation of the guide part 110. For example, the electrode tabs 15 may be gathered on the predetermined area G while the first and second rods 111 and 112 respectively move toward each other. Alternatively, in a state in which the second rod 112 supports the electrode tabs 15 from below, the first rod 111 may press the electrode tabs 15 below, from above, so that the electrode tabs 15 are gathered on the predetermined area. As described above, the electrode tabs 15 may be pressed from upper and lower sides to gather the electrode tabs 15.

Next, as illustrated in FIG. 5C, the electrode tabs 15 are pressed toward the electrode assembly 10 in the state of gathering the electrode tabs 15. Due to this pressure, at least a portion of the electrode tabs 15 may be pulled toward the electrode assembly 10. This may be implemented by an operation of the guide part 110. For example, the first and second rod rollers 111b and 112b may press the electrode tabs 15 in the vertical direction according to the vertical movement of the first and second rod bodies 111a and 112a. In the pressed state, the first and second rod rollers 111b and 112b may press the electrode tabs 15 toward the electrode assembly 10 along the horizontal movement of the first and second bodies 111a and 112a. Due to this pressure, at least a portion of the electrode tabs 15 (e.g., the uppermost or lowermost electrode tab in FIG. 4) may be pulled toward the electrode assembly 10.

Next, as illustrated in FIG. 5D, the electrode tabs 15 are welded on the welding area W through the welding part 120 in the state of pulling the electrode tabs 15.

Through this process, in at least a portion of the electrode tabs 15, the ‘length L (see FIG. 5D) from the electrode assembly 10 to the welding area W’ may increase, and in this state, the electrode tabs 15 may be welded to each other. As a result, in at least a portion of the electrode tabs 15 (e.g., the electrode tab 15c), as illustrated in FIG. 5E, a length from the electrode assembly 10 to the welding area W may increase in comparison to a case in which there is no pulling process. For reference, the increase in length as described above may be larger as the electrode tab 15 is disposed closer to the guide part 110.

### Embodiment 2

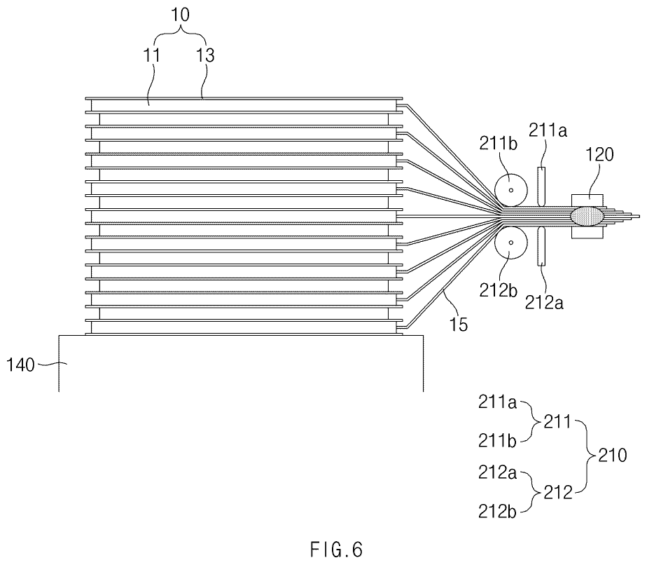

FIG. 6 is a view illustrating an apparatus for welding an electrode tab according to Embodiment 2 of the present invention. The welding apparatus according to Embodiment 2 is different from the welding apparatus according to Embodiment 1 with respect to a guide part. Hereinafter, the guide part according to Embodiment 2 will be mainly described. For reference, the matters described in Embodiment 1 may be applied to Embodiment 2 in the same or similar manner.

The guide part 210 may include a first rod part 211 disposed at one side of upper and lower sides of the electrode tabs 15. FIG. 6 illustrates the first rod part 211 disposed above the electrode tabs 15. The guide part 210 may include a second rod part 212 disposed at the other side of the upper and lower sides of the electrode tabs 15. FIG. 6 illustrates the second rod part 212 disposed below the electrode tabs 15.

The first rod part 211 may include a first pressing rod 211a for pressing the electrode tabs 15 in the vertical direction. In FIG. 6, the first pressing rod 211a disposed above the electrode tabs 15 is illustrated to descend, so as to press the electrode tabs 15. The first pressing rod 211a may be implemented in various shapes capable of pressing the electrode tabs 15. In FIG. 6, a rod-shaped first pressing rod 211a having a convex lower end is illustrated. The first pressing rod 211a may descend to approach the electrode tabs 15 or ascend to move away from the electrode tabs 15. The contents with respect to the first pressing rod 211a may be equally or similarly applied to the second pressing rod 212a to be described later.

The first rod part 211 may include a first movable roller 211b configured to move toward the electrode assembly 10 and pull at least a portion of the electrode tabs 15 toward the electrode assembly 10. The first movable roller 211b may be implemented in various shapes capable of pulling the electrode tabs 15. In FIG. 6, a roller-shaped first movable roller 211b is illustrated. The first movable roller 211b moves in a direction approaching the electrode assembly 10 (e.g., a left direction with reference to FIG. 6) and a direction away from the electrode assembly 10 (e.g., a right direction with reference to FIG. 6). In addition, the first movable roller 211b may move downward to approach the electrode tabs 15 or upward to move away from the electrode tabs 15. The contents of the first movable roller 211b may be equally or similarly applied to the second movable roller 212b to be described later.

The second rod part 212 may include a second pressing rod 212a for pressing the electrode tabs 15 together with the first pressing rod 211a in a vertical direction by relative movement of the second pressing rod 212a with respect to the first pressing rod 211a. The relative movement of the second pressing rod 212a may be described as a case in which the second pressing rod 212a moves toward the first pressing rod 211a in a stationary state of the first pressing rod 211a, a case in which the first pressing rod 211a moves toward the second pressing rod 212a in a stationary state of the second pressing rod 212a, or a case in which the first and second pressing rods 211a and 212a move relatively toward each other. Due to the relative movement of the first and second pressing rods 211a and 212a, the electrode tabs 15 may be pressed in the vertical direction, and thus, the electrode tabs 15 may be gathered on the predetermined area.

The second rod part 212 may include a second movable roller 212b configured to move toward the electrode assembly 10 by being interlocked with the first movable roller 211b in the state in which the electrode tabs 15 are pressed vertically by the first and second pressing rods 211a and 212a. For example, when the first movable roller 211b moves, the second movable roller 212b may also move together.

In the state in which the first and second pressing rods 211a and 212a move relatively toward each other to gather the electrode tabs 15 on a predetermined gathering area, the first and second movable rollers 211b and 212b may move together toward the electrode assembly 10 to increase a ‘length from the electrode assembly 10 to the welding (scheduled) area’ in at least a portion of the electrode tabs 15 (e.g., the uppermost or lowermost electrode tab of the electrode tabs). After the increase in length as described above, the welding part 120 may weld the electrode tabs 15 on the welding area. For reference, the first and second movable rollers 211b and 212b may be spaced apart from the electrode tabs 15 in the vertical direction, and then move toward the electrode assembly 10 after approaching the electrode tabs 15. It may also be considered that the guide part 210 includes only the first movable roller 211b to press the electrode tabs 15.

The above-disclosed subject matter is to be considered illustrative, and not restrictive, and the appended claims are intended to cover all such modifications, enhancements, and other embodiments, which fall within the true spirit and scope of the present invention.

Thus, the above embodiments of the present invention are to be considered illustrative, and not restrictive, and the technical spirit of the present invention is not limited to the foregoing embodiments.

Therefore, the scope of the present disclosure is defined not by the detailed description of the disclosure but by the appended claims, and all differences within the scope will be construed as being included in the present disclosure.

1. An apparatus for welding electrode tabs protruding from an electrode assembly to each other, the apparatus comprising:
a guide part configured to gather the electrode tabs; and
a welding part configured to weld the electrode tabs gathered by the guide part on a predetermined welding area,
wherein the guide part is configured to press the electrode tabs toward the electrode assembly while moving toward the electrode assembly, such-se that a length from the electrode assembly to the welding area increases in at least a portion of the electrode tabs before being welded by the welding part.

2. The apparatus of claim 1, wherein the guide part includes a first rod disposed at one of upper and lower sides of the electrode tabs and a second rod disposed at the other of the upper and lower sides of the electrode tabs, when electrodes and separators of the electrode assembly are stacked in a vertical direction perpendicular to the ground, and
wherein the first rod is configured to move in a proximity direction directed toward the electrode assembly.

3. The apparatus of claim 2, wherein the first and second rods are configured to relatively move toward each other so as to adjust a distance therebetween in the vertical direction.

4. The apparatus of claim 3, wherein the first rod is configured to move in the proximity direction in a state in which the first and second rods relatively move toward each other to press the electrode tabs in the vertical direction.

5. The apparatus of claim 2, wherein the first rod includes:
a first rod body configured to move in the proximity direction; and
a first rod roller disposed on an end of the first rod body positioned closer to the electrode tabs so as to be in contact with the electrode tab that is disposed to be closest among the electrode tabs to rotate when moving in the proximity direction.

6. The apparatus of claim 5, wherein the second rod includes:
a second rod body configured to move in the proximity direction by being interlocked with the first rod body; and
a second rod roller disposed on an end of the second rod body positioned closer to the electrode tabs so as to be in contact with the electrode tab that is disposed to be closest among the electrode tabs to rotate in a state of pressing the electrode tabs in the vertical direction together with the first rod roller when moving in the proximity direction.

7. The apparatus of claim 1, wherein the guide part includes a first rod part disposed at one of upper and lower sides of the electrode tabs and a second rod part disposed at the other of the upper and lower sides of the electrode tabs, when electrodes and separators of the electrode assembly are stacked in a vertical direction perpendicular to the ground,
wherein the first rod part includes a first pressing rod for pressing the electrode tabs in the vertical direction and a first movable roller configured to move toward the electrode assembly and configured to pull at least a portion of the electrode tabs toward the electrode assembly, and
the second rod part includes a second pressing rod configured to moves in the vertical direction, with respect to the first pressing rod, to press the electrode tabs in the vertical direction together with the first pressing rod.

8. The apparatus of claim 7, wherein the second rod part further comprises a second movable roller configured to move toward the electrode assembly by being interlocked with the first movable roller in a state in which the electrode tabs are pressed in the vertical direction by the first and second pressing rods.

9. A method for welding electrode tabs protruding from an electrode assembly, the method comprising:
(a) pressing the electrode tabs upward and downward to gather the electrode tabs, when electrodes and separators of the electrode assembly are stacked in a vertical direction perpendicular to the ground;
(b) pressing the electrode tabs toward the electrode assembly in a state of gathering the electrode tabs to cause pulling of at least a portion of the electrode tabs toward the electrode assembly; and
(c) welding the electrode tabs on a predetermined welding area after the pulling.

10. The method of claim 9, wherein the at least a portion of the electrode tabs is welded in a state in which a length from the electrode assembly to the welding area increases by the pulling.

11. The method of claim 9, wherein step (b) includes allowing a first rod disposed at one of upper and lower sides of the electrode tabs to move toward the electrode assembly so as to press the at least a portion of the electrode tabs toward the electrode assembly.

12. The method of claim 11, wherein step (a) includes allowing a second rod disposed at the other of the upper and lower sides of the electrode tabs to press the electrode tabs upward and downward together with the first rod.

13. The method of claim 12, wherein the first rod includes a first rod roller configured to be movable in a proximity direction directed toward the electrode assembly, in a separation direction directed away from the electrode assembly, and in an upward or downward direction, the first rod roller configured to be in contact with the electrode tab that is disposed to be closest among the electrode tabs to rotate when moving in the proximity direction.
